(19) United States
(12) Patent Application Publication
(10) Pub. No.: US 2025/0097153 A1
(43) Pub. Date: Mar. 20, 2025

(54) MECHANISM FOR DETECTING AND MITIGATING CONGESTION IN A DRAGONFLY NETWORK

(71) Applicant: NVIDIA Corp., Santa Clara, CA (US)

(72) Inventors: John Martin Snyder, San Rafael, CA (US); Nan Jiang, Sudbury, MA (US); Dennis Charles Abts, Rochester, MN (US); Larry Robert Dennison, Mendon, MA (US)

(73) Assignee: NVIDIA Corp., Santa Clara, CA (US)

(21) Appl. No.: 18/646,410

(22) Filed: Apr. 25, 2024

Related U.S. Application Data
(60) Provisional application No. 63/582,782, filed on Sep. 14, 2023.

(51) Int. Cl. H04L 47/122; H04L 47/125

(52) U.S. Cl. CPC H04L 47/122; H04L 47/125

(57) ABSTRACT

A process to manage congestion in a network involves converting traffic received from the local endpoints to a bandwidth demand for one or more destination endpoint in a remote group, and determining a sum over the destination endpoints of a minimum of a maximum bandwidth of a link and a bandwidth demand to one or more of the remote endpoints.

### CROSS-REFERENCE TO RELATED APPLICATIONS

This application claims priority and benefit under 35 USC 119 (e) to U.S. Application No. 63/582,782, filed on Sep. 14, 2023 and titled “Mechanism for Detecting and Mitigating Congestion in a Dragonfly Network”, the contents of which are incorporated herein by reference in their entirety.

### BACKGROUND

Supercomputers and high-performance computing systems may utilize Dragonfly network topologies to interconnect numerous computing nodes. Dragonfly topologies scale to large system sizes while maintaining a compact overall footprint. In some common Dragonfly topologies, the path between any two endpoints comprises a maximum of three hops.

The Dragonfly topology partitions endpoints into local groups. In some Dragonflies, endpoints within a group may be connected to one another via short, inexpensive paths (e.g., electrical links/buses). A local group acts as a virtual router with ports that connect to other local groups (e.g., using optical links). Endpoints within a group may communicate with one another over inexpensive electrical signaling, with a reduced number of longer, costly optical links (for example) providing global communication among the groups.

The relatively low cost, low diameter, high throughput, and scalability of Dragonfly networks compared to other network topologies makes them an attractive option for large-scale computing systems.

Congestion occurs in a Dragonfly network when links are over-subscribed, meaning bandwidth demand on the links exceeds the bandwidth capacity of the links. When congestion occurs, packets accumulate in the switch buffers. This incurs queuing delay and/or packet loss reducing network performance.

Dragonfly networks may manage congestion by one or both of avoiding the congestion through intelligent routing decisions and throttling endpoint packet injection rates. The latter approach is less desirable because it impacts the throughput of the endpoints. In some circumstances, the network's physical structure may be insufficient to support the traffic pattern to full potential. In these situations endpoint throttling may be required to avoid congestion.

In a Dragonfly topology, there may be exactly one minimal path between any source-destination endpoint pair. A minimal path comprises a single global link. So-called “non-minimal” routing (utilizing two or more global links) between two endpoints, over paths other than the minimal one, may be utilized to spread the traffic load across local and/or global links. Existing Dragonfly protocols detect congestion on the minimal path and respond by routing traffic on non-minimal paths. Conventional mechanisms for non-minimal routing may improve network throughput in certain traffic patterns but may reduce throughput in others. For example, conventional implementations of non-minimal routing during endpoint congestion may reduce overall network performance in some cases.

Various conventional congestion control protocols detect congestion and throttle endpoint injection rates, but none are integrated with a routing algorithm that advantageously utilizes path diversity to reduce congestion. Conventional congestion management schemes are implemented at the endpoint network interface and tend to be operated independently from the routing algorithms utilized in the network. This operational separation impedes improvements in network utilization under a variety of traffic conditions.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A-FIG. 1C depict an adversarial traffic scenario in a Dragonfly network.

FIG. 2A-FIG. 2C depict an example of group incast with cross traffic.

FIG. 3 depicts an example of two endpoint sub-groups performing split incast.

FIG. 4 depicts an example of global port congestion during adversarial traffic conditions.

FIG. 5A-FIG. 5D depict non-minimal traffic on a global link.

FIG. 6 depicts incast traffic congestion on a global port.

FIG. 7 depicts an example of split incast traffic.

FIG. 8A depicts an exemplary network traffic management algorithm.

FIG. 8B depicts settings conveyed by control packets in one embodiment.

FIG. 8C illustrates an aspect of the subject matter in accordance with one embodiment.

FIG. 9 depicts an exemplary algorithm for detecting incast traffic originating from multiple groups.

### DETAILED DESCRIPTION

Routing over non-minimal paths causes packets to traverse extra links than they would if routed minimally, thereby reducing the network's bisection bandwidth and increasing packet latency. Worst-case traffic patterns may reduce a Dragonfly's effective core throughput by, for example, up to 50%. Preventing network congestion during certain traffic scenarios may call for the use of both injection rate throttling at source endpoints and non-minimal routing to destination endpoints.

Disclosed herein are mechanisms that integrate congestion management with non-minimal routing to achieve improved throughput for certain congestion-causing traffic patterns. The disclosed mechanisms may be utilized in Dragonfly networks to route packets non-minimally only on condition that non-minimal routing improves system throughput. The disclosed mechanisms may also be utilized to detect inadmissible traffic and throttle endpoints in response, and to enable endpoints to observe the network state with low latency and rapidly adapt to changes in traffic characteristics.

Network traffic patterns may benefit from a combination of both non-minimal routing and endpoint throttling that conventional protocols fail to identify. The disclosed mechanisms utilize telemetry signals from switches to identify and select a routing policy, and throttle endpoints in circumstances in which traffic is inadmissible. The disclosed mechanisms may enable sustained throughput of over 50% for adversarial traffic, and may perform near optimally (as determined by conventional network performance metrics) on both benign and inadmissible traffic patterns.

On condition that the network enters a state where traffic over-utilizes links and congestion occurs, the disclosed mechanisms generate telemetry packets. The telemetry packets, which may be control packets or parameter-bearing packets or a combination thereof, are communicated to endpoints and applied there to adjust endpoint injection rates and routing. Unlike conventional congestion control protocols that detect congestion and respond by either rerouting packets or throttling endpoints, the disclosed mechanisms calculate contention on oversubscribed links and determine whether one, or a combination of both of these mechanisms is best for endpoints to implement under the circumstances.

Over-contention for links leads to congestion, so that preventing or mitigating contention also prevents/mitigates further congestion. The disclosed mechanisms demonstrate low (comparative to conventional algorithms) levels of packet misrouting and therefore achieve higher performance even in the presence of traffic patterns that would confuse (cause malfunction or poor performance of) conventional non-minimal routing protocols.

The disclosed mechanisms track contention on global links and determine whether non-minimally routing or throttling packet injection, or both, will improve network throughput. The disclosed mechanisms generate contention notification/control packets to endpoints, which communicate a summary of the contention metrics generated at global link ports, including a percentage of traffic to route non-minimally and an extent to which to throttle packet injection. Global ports communicate the contention packets to endpoints within the global port's group. Endpoints receive the contention packets and adjust their routing and packet injection accordingly.

Logic on each global port may track packets arriving at the port. The ports may utilize lookup tables tracking the bytes sent from each endpoint in the port's local group to the remote group on the other end of the global link. This table tracks only a local group so that, for example, a radix-64 Dragonfly utilizes 532 entries per global port. An entry in the table stores a counter that is incremented every time a minimally routed packet arrives at the global port. Based on the metrics of minimally routed packets on global ports, a combination of non-minimal routing and packet injection throttling for endpoints is determined that improves throughput without generating congestion.

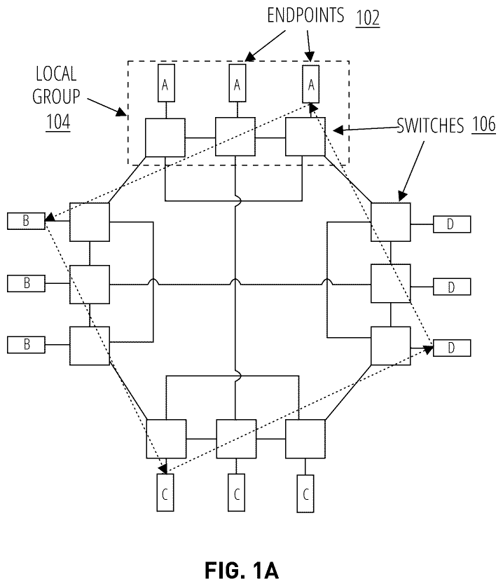

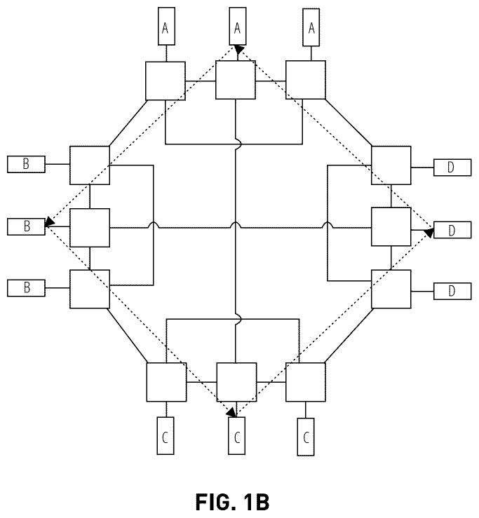

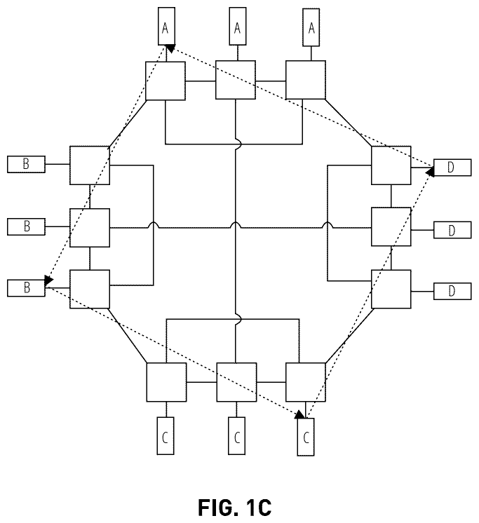

FIG. 1A-FIG. 1C depict an adversarial traffic scenario in a Dragonfly network.

Adversarial traffic occurs when endpoints 102 in a local group 104 send packets to a different destination in the same remote group. The adversarial traffic depicted in FIG. 1A-FIG. 1C takes place between fully connected groups, wherein each endpoint communicates packets to a different endpoint in the neighboring group in the counter-clockwise direction. Physical links are depicted with solid lines, packet movement is depicted with dotted lines, and arrows depict the packet's direction through the network. Global links span between different endpoint groups; local links span between switches within a local group 104.

In the depicted example, each endpoint injects one unit of bandwidth, creating a demand of three units for each minimal path. Each link can convey only one unit of bandwidth at a time, so to alleviate the excess demand on the minimal path between the two groups, the network routes packets non-minimally. Non-minimal routing spreads the traffic across the Dragonfly's global links and improves network throughput.

Although conventional protocols route traffic non-minimally to improve adversarial traffic throughput, they do not also throttle the injection of non-minimal traffic during adversarial traffic. In a Dragonfly topology, endpoint injection bandwidth matches global link bandwidth because each switch comprises a same number of endpoints as global links.

Bisection bandwidth refers to the maximum traffic that can move simultaneously between the two halves of the network without causing congestion or performance degradation. To achieve full bisection bandwidth in a Dragonfly network, each packet may traverse only a single global link. However, when the network routes a packet non-minimally, the packet traverse at least two global links. For example, in a non-minimal route a first global link may move the packet to an intermediate group, and a second global link may move the packet to the destination group.

Conventional non-minimal routing algorithms improve throughput for the traffic pattern depicted in FIG. 1A-FIG. 1C, at the expense of halving the network's bisection bandwidth. Therefore, if endpoints do not reduce their injection rates during adversarial traffic, the network congests. In practice, congestion in lossless networks may cause performance interference, and congestion in lossy networks degrades performance. To avoid congestion, endpoints should also throttle endpoint packet injection during adversarial traffic, especially during high traffic loads.

The initiation of non-minimal routing in response to congested global links may not improve network performance in every circumstance because the global link bandwidth may not be the causal bottleneck.

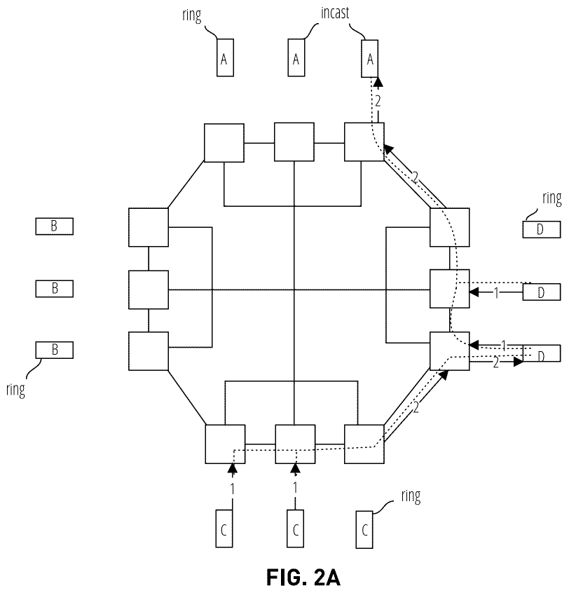

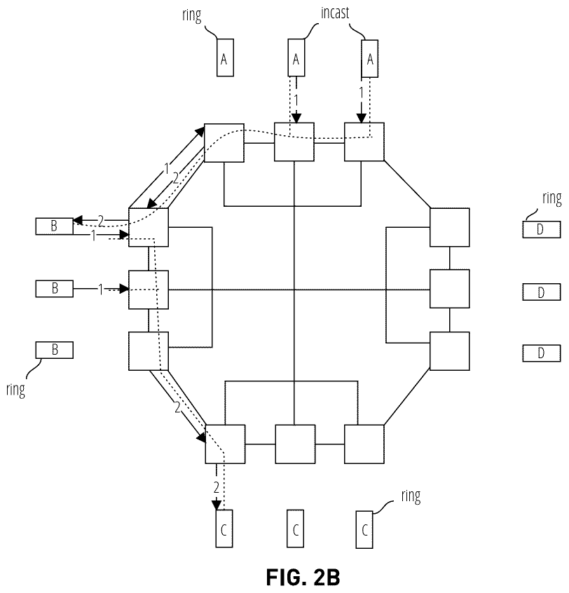

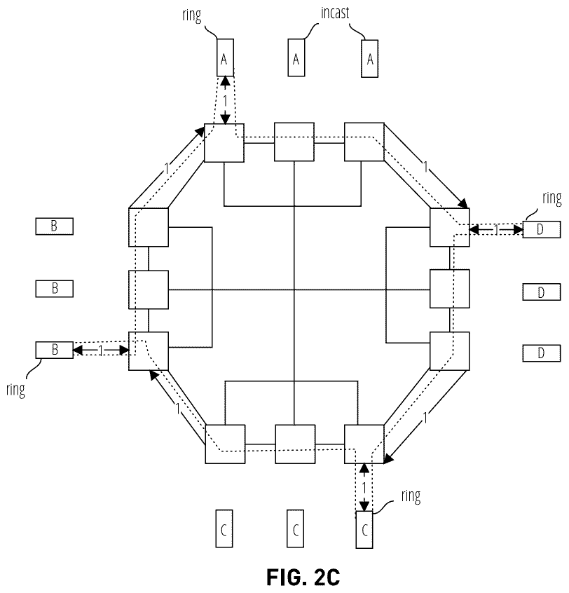

FIG. 2A-FIG. 2C depict an example of group incast with cross traffic, a traffic pattern during which non-minimal routing does not improve performance and may degrade throughput. The traffic pattern comprises two main aspects: 1) each endpoint group performs incast (counterclockwise in the depicted exampleFIG. 2A and FIG. 2B) to an endpoint in another group, and 2) there exists a ring of cross traffic between certain endpoints (depicted clockwise-FIG. 2C). For example, both endpoints in group A communicate packets to the first endpoint in group B. This incast causes congestion on the global link from group A to group B, but non-minimal routing does not improve throughput because the true bottleneck is the destination link's bandwidth. Therefore, throttling the two endpoints marked “incast” in FIG. 2B to 50% load is the correct solution, so these source endpoints do not overwhelm the destination endpoint.

Conventional protocols trigger throttling based on queue depth without factoring in where other bottlenecks may arise. This spreads the congestion into other portions of the network, resulting in potential performance degradation. During group incast with cross traffic, routing the incast traffic non-minimally reduces the ring's throughput. Some conventional protocols address this issue by identifying when congestion is caused by incast traffic, and in response routing the incast traffic using only the minimal paths.

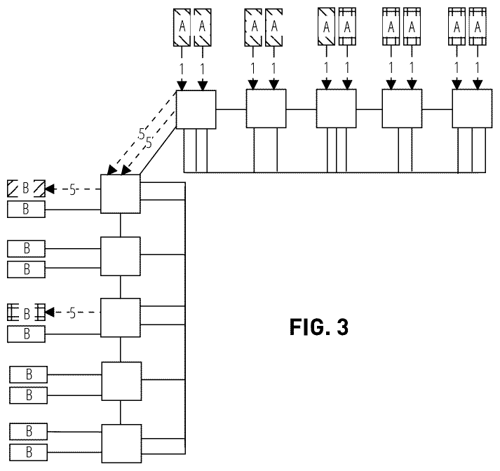

Split incast traffic patterns may benefit from both non-minimal routing and endpoint congestion control. FIG. 3 depicts an example of two endpoint sub-groups performing split incast on an 8-radix Dragonfly network. Each sub-group of endpoints in group A send packets to a single corresponding endpoint in group B (as indicated by the fill patterns of the endpoints). Although incast traffic from only a single group is depicted for simplicity, in the full network every group may for example perform split incast, for example to a destination in its counter-clockwise neighbor group.

To maximize throughput and minimize congestion in this split incast scenario, the switches may route traffic non-minimally and the source endpoints may throttle packet injection. Because the incast to endpoint ratio is 5:1, the source endpoints should reduce their injection to 20% of their maximum incast bandwidth, obviating congestion at the destination endpoint. However, each group has 10 endpoints in total, each injecting at 20% maximum capacity, which results in congestion of the global link. To mitigate congestion, each endpoint may be configured to route 50% of its traffic non-minimally. This alleviates global link congestion without reducing overall network throughput. Forcing incast traffic to only take the minimal paths (as in CBCM protocols) limits throughput in this scenario to 50% of maximum, whereas the disclosed mechanisms may achieve 100% throughput in these traffic scenarios without causing congestion.

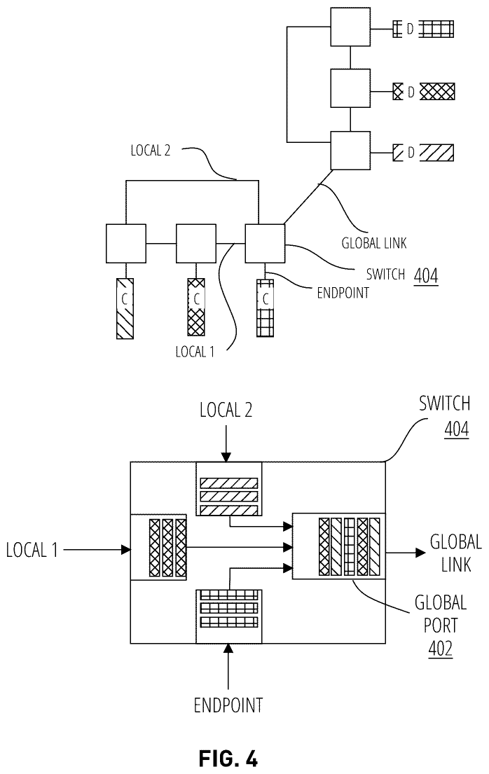

FIG. 4 depicts an example of global port congestion during adversarial traffic conditions. As an example, assume the network is a 4-radix Dragonfly with 200 Gbps maximum bandwidth links, wherein network traffic conditions are sampled every 500 ns. The traffic state is measured over this sampling interval and routing and packet injection adjustments are calculated for the endpoints accordingly.

FIG. 4 depicts an exemplary state of a global port 402 on a switch 404 that intermediates traffic between groups C and D. Each endpoint in group C sends packets to a different endpoint in group D (as indicated by the fill patterns), for example at a 12.5 KB rate, which is the maximum rate at which a source can inject packets in 500 ns at 200 Gbps.

The network traffic management logic converts the incast bytes received to the bandwidth demand for each destination endpoint in the remote group. In this example, the demand is 200 Gbps for each destination endpoint. The traffic manager determines a sum over all destinations of the minimum of (a) maximum link bandwidths Rₘₐₓ (200 Gbps in this example), and (b) the demand R_{d} to the destination.

$${R}_{sum} = {\sum }_{d}^{destinations} min ( {R}_{d} , {R}_{max} ) \qquad Equation 1$$

The traffic manager calculates a percent of the traffic to route non-minimally based on this sum.

$$\% to route non\_minimally = 1 - \frac{{R}_{max}}{{R}_{sum}} \qquad Equation 2$$

Because the packets have different destinations, the system identifies the bottleneck to be the minimal global link between the two groups, and determines that non-minimal routing will improve throughput. Because the contention ratio is 3:1 (600 Gbps demand on the link/200 Gbps link bandwidth), the traffic manager determines that 66% of the traffic should be routed non-minimally (1-200/600=0.66). There are three paths between the two groups (1 minimal path and 2 non-minimal paths), so that this mechanism spreads the traffic from group C to D evenly across the three paths.

Maximizing throughput and minimizing latency during adversarial traffic may involve more than non-minimal routing. The system may also throttle endpoints because non-minimal routing reduces the network's bisection bandwidth.

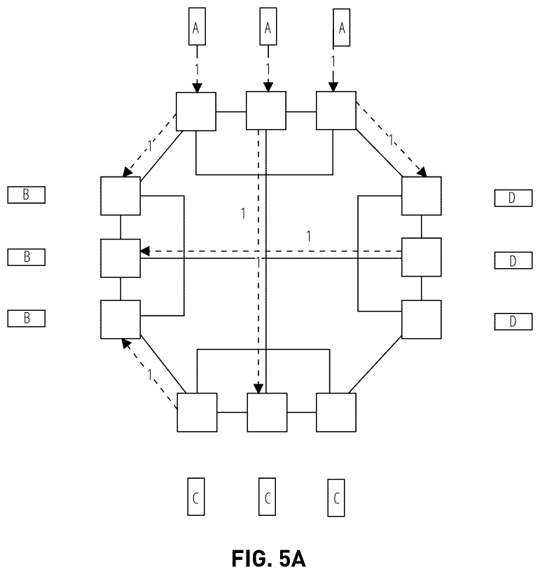

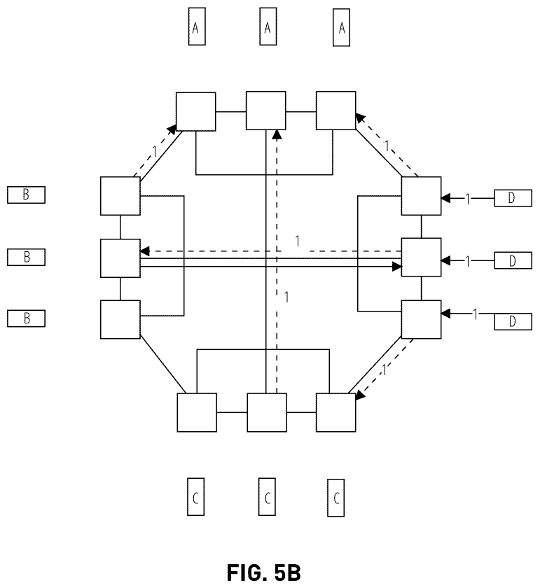

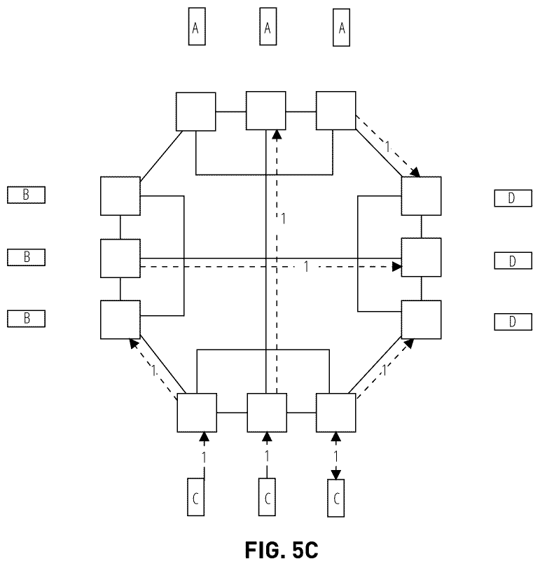

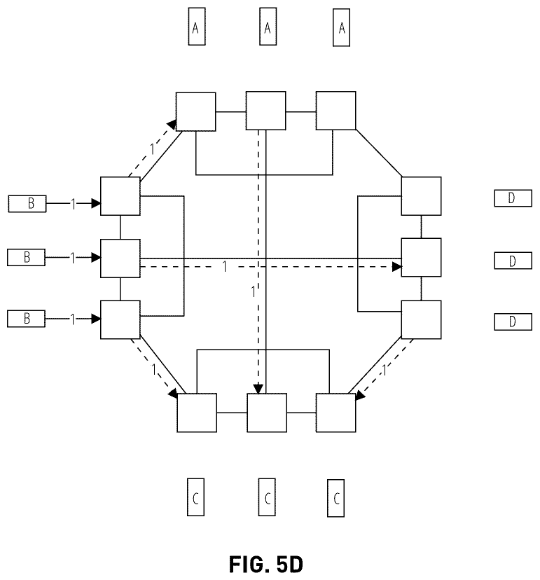

FIG. 5A-FIG. 5D depict non-minimal traffic on the global link between groups C and D. Group A and group C also route non-minimal traffic along this link. Both groups inject at full bandwidth, generating 2:1 contention for the link (400 Gbps demand vs 200 Gbps link capacity). The system may track a total of the non-minimal bytes sent over the link, regardless of destination. Based on the non-minimal traffic demand, the system may calculate settings indicating to what extent each endpoint should throttle non-minimal traffic. These settings are communicated to endpoints within the group. In this example, the system may instruct the endpoints to reduce non-minimal injection rates by 50%. This reduces congestion on non-minimal paths but still maximizes throughput.

$$non\_minimal \% throttle = \frac{{R}_{max}}{{R}_{non\_min}} = 0.5$$

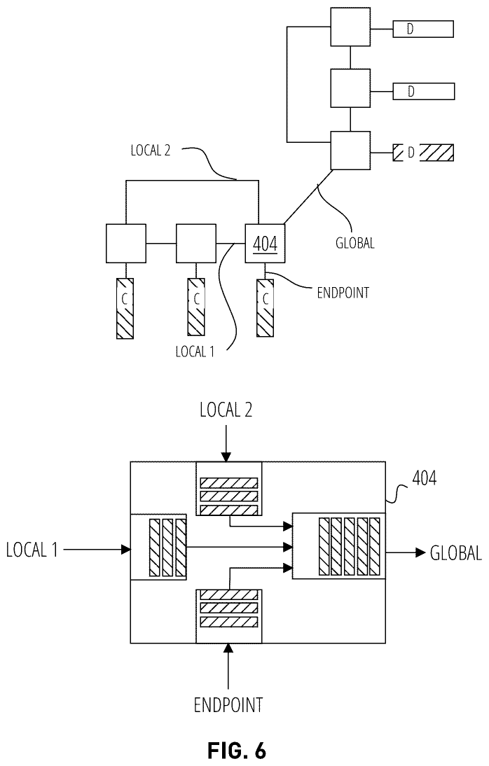

If a global link is overly contended, non-minimal routing is not always optimal or even beneficial. FIG. 6 depicts system operation during exemplary group incast traffic. In this example there is no cross traffic. The system may track the bandwidth demand for each destination. For example, after a sampling interval, the system may calculate that the demand Ra to the shaded destination in D is 600 Gbps, meaning there is a 3:1 contention ratio for the global link between groups C and D (assuming an Rₘₐₓ of 200 Gbps on the global link).

Applying Equation 1, the system calculates the value Rₛᵤₘ for the single destination endpoint. This comes to 200 Gbps in this example, because it evaluates to the minimum of Rₘₐₓ (200 Gbps) and R_{d} (600 Gbps). Because all packets are directed to the same destination endpoint, the destination endpoint is the bottleneck, and non-minimal routing will not improve performance. This is determined by applying Equation 2 for the non-minimal routing percentage:

$$1 - \frac{{R}_{max}}{{R}_{sum}} = 1 - \frac{200 Gbps}{200 Gbps} = 0$$

It follows that ingress (source) endpoints should throttle their injection to reduce the congestion. The new injection rate is determined by dividing the maximum bandwidth Rₘₐₓ (200 Gbps) by the total demand to the destination R_{d} (600 Gbps), which comes to 33%. To achieve this lower injection rate, the system communicates settings to each endpoint in Group C to reduce traffic injection by 66%. This ensures the minimal path is fully utilized and endpoints do not route traffic non-minimally with no beneficial effect.

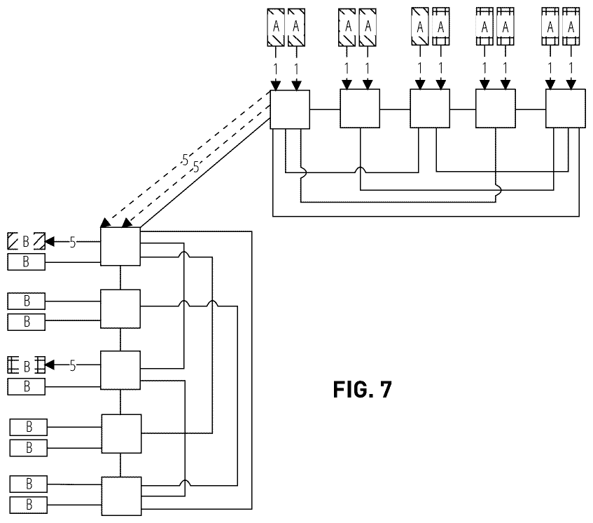

Certain traffic patterns benefit from both non-minimal routing and endpoint throttling. FIG. 7 depicts an example of split incast traffic. The system detects that the bandwidth on the local link between groups A and B is heavily contended. The demand to each of the shaded destinations in group B may, for example, be 1 Tbps (e.g., each endpoint in A injecting at 200 Gbps). Applying Equation 1 and Rₘₐₓ=200 Gbps, the system calculates Rₛᵤₘ to be 400 Gb/s and determines from Equation 2 that the endpoints should route half the traffic non-minimally:

$$1 - \frac{200}{400} = 0.5$$

The system calculates that the destinations are experiencing a 5:1 incast contention ratio, and determines that each endpoint in Group A should throttle its packet injection to 0.2 of its current injection bandwidth

$$( \frac{{R}_{max}}{{R}_{d}} = 0.2 ) .$$

This routes half the traffic non-minimally and simultaneously throttles endpoints to 20% of their maximum injection rate, balancing between endpoint throttling and non-minimal routing.

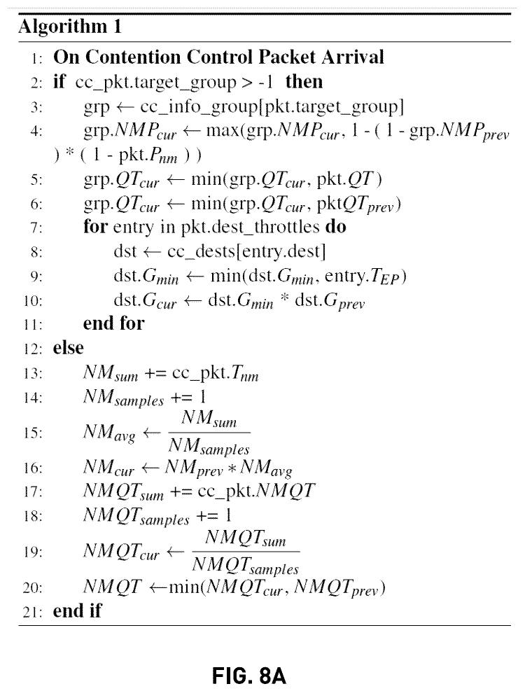

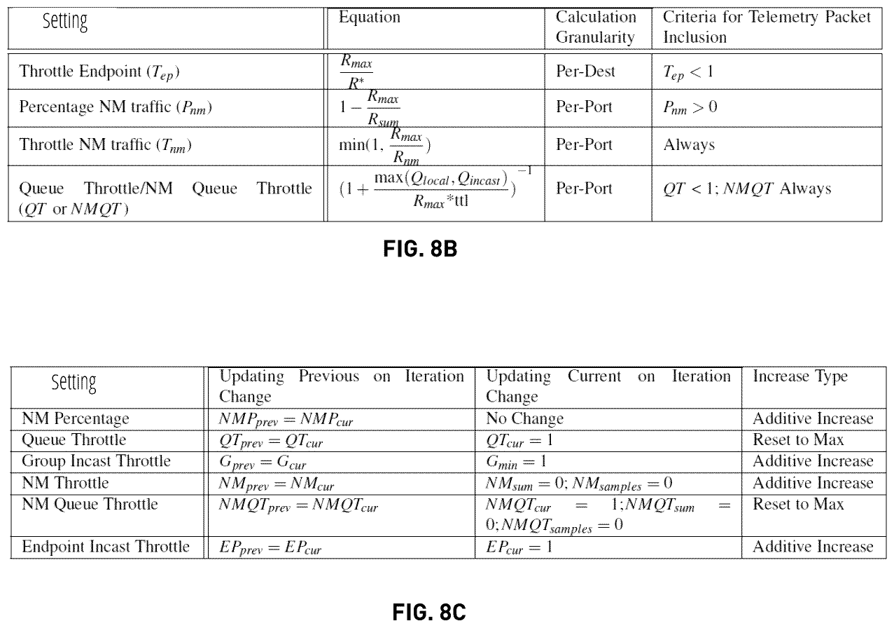

FIG. 8A depicts an exemplary network traffic management algorithm. The system may implement contention sensing on global links across the network, and injection rate throttling at the endpoints. The network switches may be configured to measure both packet flow rates and packet trajectories based on the destinations specified in the packet headers. The network switches aggregate contention metrics for their ports into telemetry packets that they broadcast to the endpoint groups. This mechanism provides feedback among the switches and the destination endpoints, enabling responsive upstream injection rate and routing adjustments in response to downstream contention.

Destination-based tracking of packets traversing the global links provides a mechanism to sense and track contention across the global links, which in many embodiments are optical links. The system may sense “hotspots” (areas of high contention) among the global links and generate control packets to adjust routing and endpoint throttling to improve the overall network throughput. For each unique destination endpoint, the system may update a counter of packets sent over a minimal path to that destination. The system may also update a non-minimal tracking counter for packets that traverse a non-minimal path, regardless of their origin or destination. Contention control packets are generated with settings for endpoints to adjust their routing and packet injection rate. FIG. 8B depicts settings conveyed by control packets in one embodiment.

The system may evaluate the traffic circumstances of each endpoint periodically and determine whether endpoints should throttle traffic to each destination. The system may convert a number of bytes received on a global link for a particular destination during a sampling interval to a traffic rate (R_{d}):

$${R}_{d} = \frac{{B}_{d}}{sampling interval}$$

where B_{d} is the bytes received on the global link directed to destination d during the sampling interval. To determine if the destination is the bandwidth bottleneck, the system may divide the maximum link bandwidth (Rₘₐₓ) by the observed traffic on the link over the sampling interval. However, this is insufficient to determine whether or not the endpoint is experiencing incast congestion. While the system actively senses traffic along the minimal path, it may also measure the total traffic in-flight to particular destinations, to correctly steer additional traffic non-minimally across global links.

As an example, suppose the minimal link bandwidth is 200 Gbps and the measured minimal link traffic to destination A is 100 Gbps. It may appear that the destination is not saturated, and the destination is not the bottleneck. However, if the source endpoints are routing only 25% of traffic to the destination A endpoint over the minimal link (Pₘᵢₙᵢₘₐₗ), then the actual (true) demand for destination A is 400 Gbps, and endpoint throttling may be called for.

One example of an algorithm to calculate the true demand rate (R*_{d}) for a destination is:

$${R}_{d}^{*} = {R}_{max} * {QR}_{prev} * ( \frac{{P}_{minimal}}{{R}_{d}} + \frac{sampling\_interval}{{I}_{d}} ) \qquad Equation 3$$

where I_{d} is the count of bytes identified in an incast control packet received from destination d. The incast byte count enables the system to handle incast traffic when not all traffic is from a single source group.

In one embodiment, an out-of-band signal is sent to global ports of the network to indicate the fraction of traffic flowing across the minimal links on the network.

To determine the traffic percentage that the system should route non-minimally, the switches may sum the demand to destinations in remote groups. Only those bytes originating from the local group of the switch may be considered when determining whether packets should be routed non-minimally. A switch may utilize the minimum of (a) the demand for each destination, and (b) the maximum bandwidth of a global link, to avoid the counter-productive routing of traffic non-minimally that should be throttled instead. Sums computed in this fashion also account for any reduced demand due to endpoint throttling. A variation of the algorithm represented in Equation 1 may be expressed as:

$${R}_{sum} = {\sum }_{d}^{destinations} min ( {R}_{max} , \frac{{T}_{ep} * {R}_{d}}{{QT}_{prev}} ) \qquad Equation 1 - 1$$

Here Tₑₚ represents the extent of traffic throttling applied to the endpoints. The system (e.g., logic implemented in the switches) may determine the percentage of traffic that endpoints should route non-minimally and include this amount in the control packets to the endpoints, on condition that the sum exceeds the link's bandwidth. The system may also calculate the non-minimal traffic demand as follows:

$${R}_{nm} = \frac{{B}_{nm}}{{NMQT}_{prev} * sampling interval} \qquad Equation 4$$

and may apply Rₙₘ to determine if endpoints need to throttle non-minimal traffic.

On the condition that a link is carrying non-minimal traffic, the system may insert Rₙₘ into the control packets for endpoints of the link, enabling the endpoints to adjust their non-minimally-routed traffic injection rate based on the average non-minimal traffic carried by global links of their group (endpoints tend to spread their traffic equally across non-minimal links). The system may take contention into account only when adjusting routing and endpoint throttling.

Queues may accumulate on the local group switches due to contention for the global link on the switch. Once the system identifies the correct parameter settings for the extant traffic pattern, congestion may not increase, but existing queues may also fail to clear. The algorithm represented in Equation 4 utilizes two parameters, QT (queue throttle) and NMQT (non-minimal queue throttle), which reflect the depth of one or more non-zero queues arising from minimal or non-minimal traffic. In these circumstances endpoints may be instructed to throttle injection to reduce queue depths.

If the global link of a switch carries minimal traffic, the system sets QT, and if the link carries non-minimal traffic, the system sets NMQT. The system sets these values based on either the existing queue size on the local switch or the queue size identified by an incast control packet. This enables the system to implement endpoint throttling to clear a queue on either a local switch or at an endpoint in a remote group that is experiencing congestion.

Packet sources may unnecessarily throttle injection rates because some sources that throttle injection may not be contributing packets to the congested destination. However, it may be advantageous to utilize a single QT parameter on contention control packets, as opposed to multiple QT parameters, each specific to a different destination in remote groups. Because congestion is typically transient, unnecessary throttling by some packet sources may be short-lived.

The endpoints receive control packets from the system and in response accordingly adjust the steady state and transient parameters that define the endpoint's injection rate and routing protocol. Steady-state behavior influences contention and transient parameters affect congestion. Steady-state control settings specify the routing of packets non-minimally and throttle packet injection based on the traffic pattern.

The system learns the steady-state settings over time. As long as the traffic pattern remains consistent, the steady-state settings (which may be local to each link) do not change. Once the system learns the steady state settings, contention is alleviated, but congestion may have built up while the links were overly contended. Transient settings are applied to temporarily reduce packet injection to clear congestion, and the system may not adjust them based on the traffic pattern.

Once congestion alleviates, transient settings are no longer applied to throttle injection, but steady state settings remain unchanged. The system adjusts steady and transient state settings differently because the two setting types each play a different role in managing the network state.

In one embodiment, the system adjusts steady-state settings using an additive-increase multiplicative-decrease (AIMD) algorithm. Multiplicative decrease occurs when switches notify endpoints about contention and endpoints change their routing protocol or throttle their injection rate to alleviate contention and avoid worsening congestion. The system may periodically increase steady-state parameters to probe for bandwidth as contention subsides.

Referring to the exemplary algorithm depicted in FIG. 8A, lines 4, 10, and 16 multiplicatively decrease the steady state settings by multiplying a variant of the settings in the contention control packet by the previous values. On each iteration, the system updates the previous value to the current value for example as depicted in FIG. 8C, which also depicts how the system may reset transient settings.

Multiplying the new value of a setting by a version of the previous value enables a protocol to react responsively to congestion or contention without overreacting. Transient state settings may not mimic AIMD mechanisms, and instead reset to their default value more responsively. Transient state settings clear existing congestion and the system may sets them based on the current congestion (queue occupancy). Transient settings essentially shift bandwidth from endpoints to the switches to clear the standing queue. Once the queue is cleared, the switches no longer need the bandwidth, and transient settings may reset to their maximum value.

Referring again to FIG. 8A, lines 5, 6, 19, and 20 show the system setting transient state settings. Instead of multiplicatively decreasing an existing setting such as steady state settings, transient settings are either set to their current values or the values from the previous iteration. When the system transitions to the next iteration, the previous values becomes the current values for the transient settings, and the current values are set to 1 (maximum injection). After two iterations with no standing queues, the transient settings reset to 1, and endpoints do not throttle traffic due to congestion.

The system may identify when non-minimal routing improves throughput on global links but take no action on local links. This may limit throughput on certain traffic patterns where traffic doesn't interfere with one other on global links but paths collided on local links. To alleviate congestion on local links, the system may reroute packets to another switch within the same group if the minimal output port is congested. Due to a typical Dragonfly's local-to-global network bandwidth ratio, this should not limit performance. Switches may track the queues on local egress ports and if the queues exceed a configured threshold, reroute the packet to different local egress ports. A local reroute may not result in re-classifying a packet as non-minimally routed.

Some embodiments of the system may implement group-level tracking of congestion. In these systems, it may be challenging to detect traffic that originates outside the group causing the congestion. This in turn may impede the system's ability to throttle endpoints during incast traffic patterns in which sources in multiple groups direct traffic to the same destination.

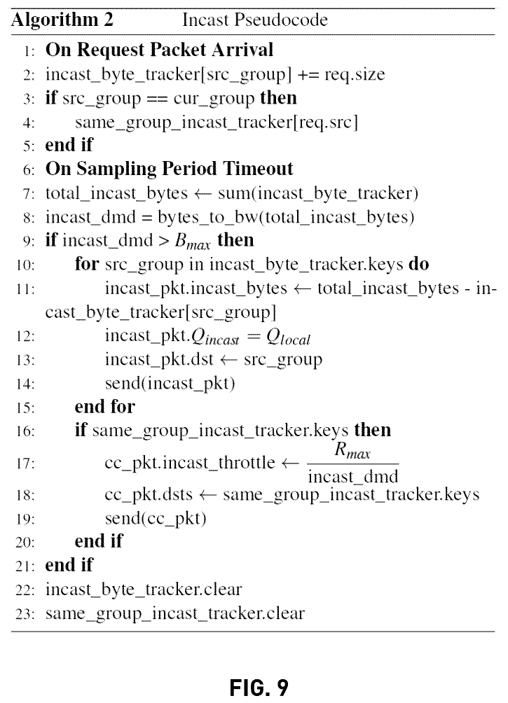

To address this problem, a mechanism may be implemented that operates on switch ports and stores measurements of incast traffic. This mechanism may notify endpoints and groups about how to throttle traffic destined for congested destinations. An exemplary algorithm for detecting incast traffic originating from multiple groups is depicted in FIG. 9.

The depicted embodiment utilizes two tables to track bytes from different sources and index based on the source group if the traffic came from a remote group (incast_byte_tracker), or based on the source endpoint if the traffic originated from the same group as the destination (same_group_incast_tracker).

Lines 1-5 depict the tables incrementing when packets arrive. For each sampling interval, the algorithm checks if the total demand for the link exceeds the maximum link bandwidth (lines 7-9). If the demand (incast_dmd) over the sampling period exceeds the maximum link bandwidth (Rₘₐₓ) then control packets are generated to throttle incast sources.

For each remote group involved in the incast, an incast information packet is generating comprising total bytes received by the endpoint minus the bytes sent from the source group (lines 10-15). Bytes from the source group may be subtracted out because the mechanisms described previously already track the bytes sent from the source group.

The minimal path's endpoint in the remote source group receives the incast information packet and stores the incast bytes in a table for the affected destination. Global ports incorporate the incast bytes in contention notification packets, described previously. Endpoints in the same group are handled differently than endpoints in other groups, because endpoints in the same group do not receive the same information because their traffic does not cross a global link.

A contention notification packet may be multicast to all endpoints in the group participating in the incast and notify them of how much they should throttle based on the current demand for the bottleneck link. Other congestion control protocols like Swift, HPCC, and CBCM may also be utilized for endpoint incast, provided these protocols were properly modified to consider only destination endpoint congestion and integrate it with the non-minimal routing.

### LISTING OF DRAWING ELEMENTS

102 endpoint
104 local group
106 switch
402 global port
404 switch

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A network comprising:
a plurality of local endpoints in a local group;
a plurality of remote endpoints in a remote group;
a switch comprising a port for a link between the local group and the remote group; and
logic to:
convert traffic received from the local endpoints to a bandwidth demand for one or more destination endpoint in a remote group; and
determine a sum over the one or more destination endpoints of a minimum of (a) a maximum bandwidth of the link, and (b) a bandwidth demand to one or more of the remote endpoints.

2. The network of claim 1, further comprising:
logic to determine a portion of the traffic received from the local endpoints to route non-minimally to one or more of the remote endpoints.

3. The network of claim 2, wherein the portion of the traffic to route non-minimally is determined from a ratio of the maximum bandwidth of the link and the sum.

4. The network of claim 1, further comprising:
logic to determine a rate of non-minimally routed traffic on the link.

5. The network of claim 4, wherein the rate of non-minimally routed traffic is endpoint independent.

6. The network of claim 4, further comprising:
logic to determine an injection rate throttle setting for the non-minimally routed traffic based on the rate of non-minimally routed traffic on the link.

7. The network of claim 6, wherein the endpoint throttle setting is determined from a ratio of the maximum bandwidth of the link and the rate of non-minimally routed traffic on the link.

8. The network of claim 1, further comprising:
a plurality of remote endpoint groups; and
logic to:
convert packet flow rates and packet trajectories for the port into aggregate contention metrics for the link; and
broadcast the contention metrics to the remote endpoint groups.

9. The network of claim 1, further comprising:
logic to determine an injection rate throttle setting for the local endpoints that reduces the depth of a queue for the port.

10. A network switch comprising:
a plurality of local ports to endpoints of a local group;
a global port for a global link;
logic to:
convert traffic received from the endpoints of the local group to a bandwidth demand for one or more destination endpoints in a remote group; and
on condition that the bandwidth demand indicates a contention condition, signal one of more of the endpoints of the local group to perform one or both of non-minimal routing and injection throttling.

11. The network switch of claim 10, wherein the contention condition is determined as a sum over the one or more destination endpoints of a minimum of (a) a maximum bandwidth of the global link, and (b) a bandwidth demand to one or more of the destination endpoints.

12. The network switch of claim 10, further comprising:
logic to determine and communicate to the endpoints of the local group an extent of traffic to route non-minimally to the one or more of the destination endpoints.

13. The network switch of claim 12, wherein the extent of the traffic to route non-minimally is determined from a ratio of the maximum bandwidth of the global link and the sum.

14. The network switch of claim 10, further comprising:
logic to determine a rate of non-minimally routed traffic on the global link.

15. The network switch of claim 14, wherein the rate of non-minimally routed traffic is endpoint-independent.

16. The network switch of claim 14, further comprising:
logic to determine an injection traffic throttle setting at the endpoints of the local group for the non-minimally routed traffic based on the rate of non-minimally routed traffic on the global link.

17. The network switch of claim 16, wherein the endpoint throttle setting is determined from a ratio of a maximum bandwidth of the global link and the rate of non-minimally routed traffic on the global link.

18. The network switch of claim 10, further comprising:
logic to:
convert packet flow rates and packet trajectories for the global link into aggregate contention metrics for the global link; and
broadcast the contention metrics to the one or more destination endpoints.

19. A network contention control process in a Dragonfly network, the process comprising:
in a switch of the Dragonfly network, converting traffic received from endpoints of a local group of the switch to a bandwidth demand for one or more destination endpoints in a remote group; and
on condition that the bandwidth demand indicates a contention condition, generating from the switch a signal one of more of the endpoints of the local group to perform one or both of non-minimal routing and injection throttling.

20. The process of claim 19, wherein the contention condition is determined as a sum over the one or more destination endpoints of a minimum of (a) a maximum bandwidth of a global link to the remote group, and (b) a bandwidth demand to one or more of the destination endpoints.
